(19) United States
(12) Patent Application Publication
(10) Pub. No.: US 2025/0253568 A1
(43) Pub. Date: Aug. 7, 2025

(54) CONNECTOR ASSEMBLY

(71) Applicants: SUZHOU OPPLE LIGHTING CO., LTD., Suzhou City (CN); OPPLE LIGHTING CO., LTD., Shanghai (CN)

(72) Inventor: Liuhua XIAO, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/187,749

(22) Filed: Apr. 23, 2025

Related U.S. Application Data
(63) Continuation of application No. PCT/CN2023/126109, filed on Oct. 24, 2023.

(30) Foreign Application Priority Data
Oct. 24, 2022 (CN) 202211302116.1
Oct. 24, 2022 (CN) 202222797344.2
Oct. 24, 2022 (CN) 202222797940.0

(51) Int. Cl. H01R 13/10; F21S 4/26; F21V 23/06; F21Y 103/10; F21Y 115/10; H01R 12/70; H01R 12/77; H01R 13/50; H01R 13/627; H01R 33/06

(52) U.S. Cl. CPC H01R 13/10; F21S 4/26; F21V 23/06; H01R 12/7023; H01R 12/7088; H01R 12/777; H01R 13/501; H01R 13/6278; H01R 33/06; F21Y 2103/10; F21Y 2115/10

(57) ABSTRACT

A connector assembly is provided, which includes: a socket, including a housing and a conductive terminal; and a plug, used to connect with the socket, including an insulating body and a plug-in terminal; in which the insulating body includes a base and an extension portion extending from the base in a direction away from the socket; the plug-in terminal includes a docking portion connected to the conductive terminal and a contact portion electrically connected to a light strip; the contact portion includes a contact arm electrically connected to the light strip and an extension arm bent and extended from one end of the contact arm; the extension portion is at least partially covered by the contact arm and the extension arm.

### CROSS REFERENCES TO RELATED APPLICATIONS

This application is based upon and claims the priority of PCT patent application No. PCT/CN2023/126109 filed on Oct. 24, 2023 which claims priority to the Chinese patent application No. 202211302116.1, filed on Oct. 24, 2022, the Chinese patent application No. 202222797940.0, filed on Oct. 24, 2022, and the Chinese patent application No. 202222797344.2, filed on Oct. 24, 2022, the entire contents of which are hereby incorporated by reference herein for all purposes.

### TECHNICAL FIELD

The present disclosure belongs to the technical field of lighting fixtures, and in particular relates to a connector assembly for a light strip.

### BACKGROUND

With the rapid development of the LED lighting industry and the gradual improvement of people's living standards, LED flexible light strips are also widely used.

### SUMMARY

The present disclosure provides a connector assembly.

According to the present disclosure, the connector assembly provided may include:
a socket, including a housing and a conductive terminal; and
a plug, used to connect with the socket, including an insulating body and a plug-in terminal; in which the insulating body may include a base and an extension portion extending from the base in a direction away from the socket; the plug-in terminal may include a docking portion connected to the conductive terminal and a contact portion electrically connected to a light strip; the contact portion may include a contact arm electrically connected to the light strip and an extension arm bent and extended from one end of the contact arm; the extension portion may beat least partially covered by the contact arm and the extension arm.

It is to be understood that both the foregoing general description and the following detailed description are exemplary and explanatory only and are not restrictive of the present disclosure.

### BRIEF DESCRIPTION OF DRAWINGS

FIG. 1 is a schematic perspective view of a first example of a connector assembly of the present disclosure.

FIG. 2 is an exploded perspective view of the connector assembly shown in FIG. 1.

FIG. 3 is an exploded perspective view of the power line and the socket in FIG. 2.

FIG. 4 is a schematic perspective view of the plug in FIG. 2.

FIG. 5 is a schematic perspective view of the plug shown in FIG. 4 from another angle.

FIG. 6 is an exploded view of the plug of FIG. 4.

FIG. 7 is a schematic perspective view of the plug-in terminal in FIG. 6 from another angle.

FIG. 8 is a schematic perspective view of the connector assembly of FIG. 1 matched with a light strip.

FIG. 9 is a schematic perspective view of FIG. 8 with the lamp tube removed.

FIG. 10 is a schematic perspective view of another example of the plug shown in FIG. 4.

FIG. 11 is a schematic perspective view of a second example of the connector assembly of the present disclosure.

FIG. 12 is an exploded perspective view of the connector assembly shown in FIG. 11.

FIG. 13 is a schematic perspective view of the plug of FIG. 12.

FIG. 14 is a cross-sectional view of the plug of FIG. 13.

FIG. 15 is an exploded perspective view of the plug shown in FIG. 13.

FIG. 16 is a schematic diagram of FIG. 15 from another angle.

FIG. 17 is a cross-sectional view of the connector assembly shown in FIG. 11.

FIG. 18 is a schematic perspective view of the connector assembly of FIG. 11 matched with a light strip.

FIG. 19 is a schematic perspective view of FIG. 18 with the lamp tube removed.

### DETAILED DESCRIPTION

In order to make the purpose, technical solutions and advantages of the present disclosure clearer, the present disclosure will be described in detail below with reference to the accompanying drawings and examples.

Sometimes, a connector plug used for a light strip is provided with an extension block at the insertion end and conductive terminals closely adhere to the extension block. When inserting the connector plug into the lamp tube of the light strip, the extension block and the conductive terminals need to be inserted into the lamp tube together. However, with such a design, when the connector plug is inserted into the lamp tube, the conductive terminals are not only prone to deformation, but also prone to incomplete contact and loosening. In view of this, it is indeed necessary to provide a connector assembly to solve the above problems.

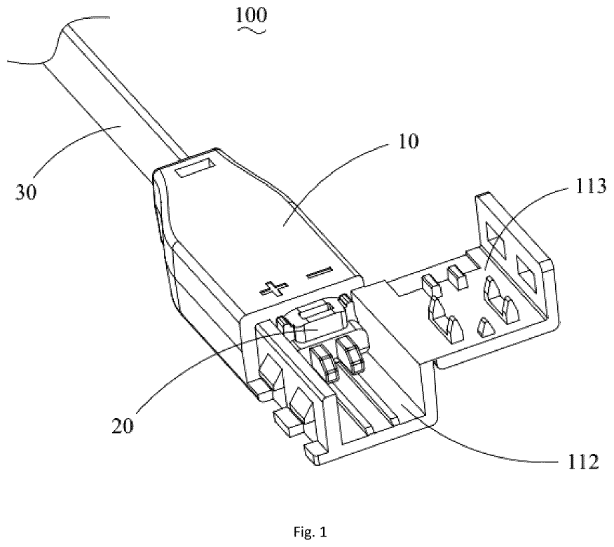

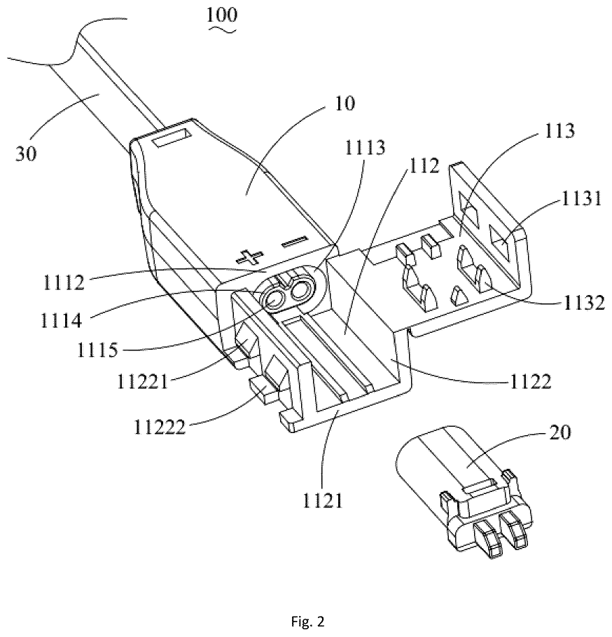

Referring to FIG. 1 and FIG. 2, the present disclosure discloses a connector assembly 100, which includes a socket 10 and a plug 20 connected to the socket 10.

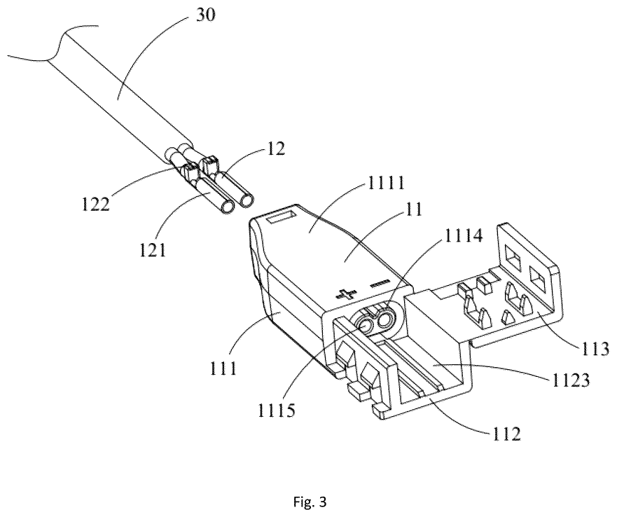

Referring to FIG. 2 and FIG. 3, the socket 10 includes a housing 11 and conductive terminals 12 installed in the housing 11. The housing 11 includes a base 111, a fixing base 112 extending from the base 111 toward the plug 20, and an end cover 113 matching the fixing base 112. The end cover 113 and the fixed base 112 are integrally injection molded and form a flip structure, so that the end cover 113 can be folded downward to achieve a fixed connection with the fixed base 112. Of course, in other examples, the end cover 113 and the fixing base 112 can also be independent components, so that the end cover 113 and the fixing base 112 can be directly connected by snapping.

The base 111 includes a base body 1111 and a docking body 1112 extending from the base body 1111 toward the plug 20. A receiving groove 1113 is formed in the docking body 1112 to receive the plug 20 and provide a space for the plug 20 to be electrically connected to the conductive terminals 12. The base 111 is further provided with a tongue plate 1114 protruding from the receiving groove 1113. A receiving cavity 1115 is provided in the tongue plate 1114. The tongue plate 1114 is preferably a plastic isolation ring.

Each of the conductive terminals 12 includes a first conductive portion 121 and a second conductive portion 122. The first conductive portion 121 is received in the receiving cavity 1115, so that the first conductive portion 121 can be isolated by the tongue plate 1114 to prevent users from getting electric shock. The first conductive portion 121 is used for connecting with the plug 20 to transmit power. In the present example, the first conductive portion 121 is arranged in a cylindrical shape. The second conductive portion 122 is fixed in the base 1111 and is used to electrically connect with the power line 30 to obtain power.

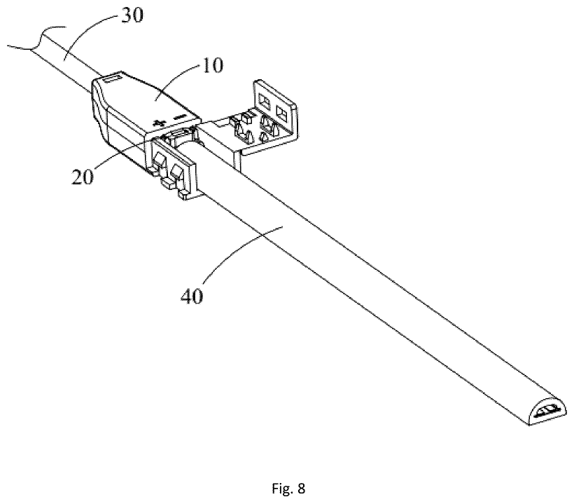

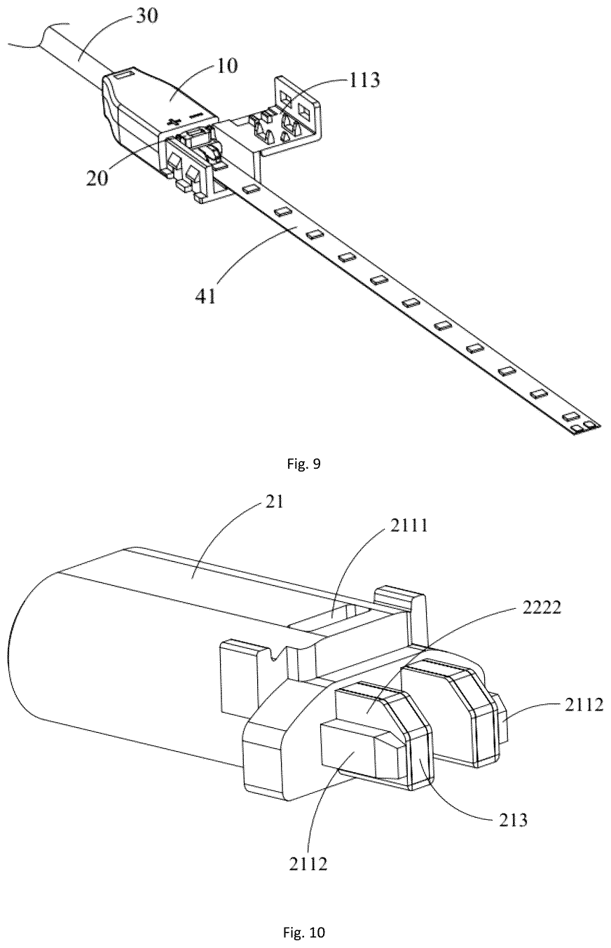

The fixed base 112 includes a bottom wall 1121 and side walls 1122 provided on both sides of the bottom wall 1121. The bottom wall 1121 and the side walls 1122 form a receiving cavity 1123 to receive the light strip 40 (as shown in FIG. 8 and FIG. 9). A first snap-fitting portion 11221 is provided on an outer wall surface of the side wall 1122. The end cover 113 is used to cooperate with the fixing base 112 to fix the light strip 40 in the accommodation cavity 1123. The end cover 113 is provided with a second snap-fitting portion 1131 that matches the first snap-fitting portion 11221, so that the first snap-fitting portion 11221 and the second snap-fitting portion 1131 can snap-fit and match with each other, so that the end cover 113 is fixed on the fixed base 112.

In the present example, the first snap-fitting portion 11221 is a protrusion, and the second snap-fitting portion 1131 is a groove that matches the protrusion. Of course, in other examples, the first snap-fitting portion 11221 may also be a groove, and the second snap-fitting portion 1131 may be a protrusion matching the groove; or, the first snap-fitting portion 11221 and the second snap-fitting portion 11221 may be other mutually matching structures, which is not limited herein.

A plurality of supporting portions 1132 are provided on an inner wall surface of the end cover 113 to resist and compress the light strip 40, so that the light strip 40 is firmly fixed in the accommodation cavity 1123. Preferably, the end of the supporting portion 1132 is sharp, so that when the supporting portion 1132 resists the light strip 40, the supporting portion 1132 can penetrate into the lamp tube of the light strip 40, thereby fixing and positioning the light strip 40 in an axial direction of the light strip 40.

Furthermore, a number of surrounding ribs 11222 are provided on the outer wall surface of the side wall 1122, which can prevent the user from disassembling it with bare hands, thus avoiding the risk of electric shock to the user.

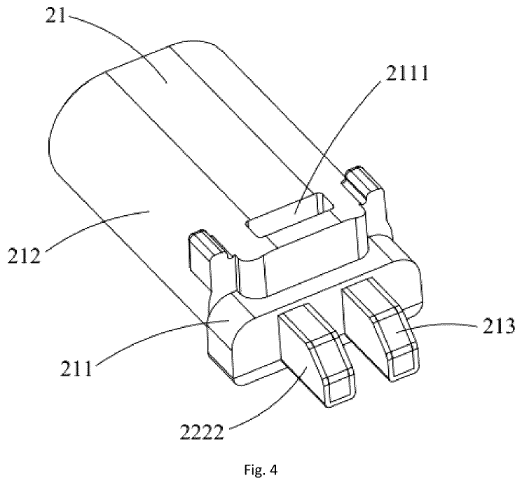

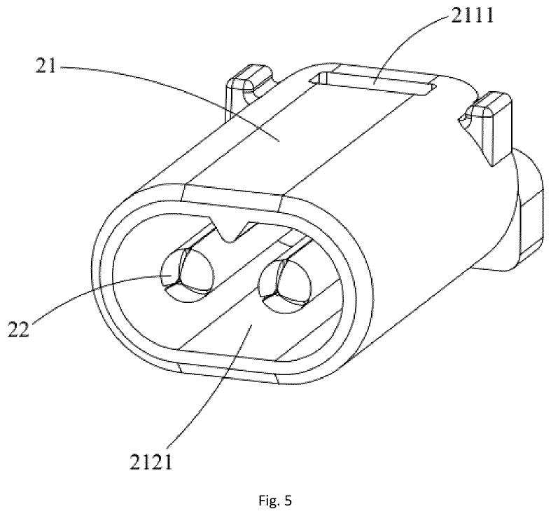

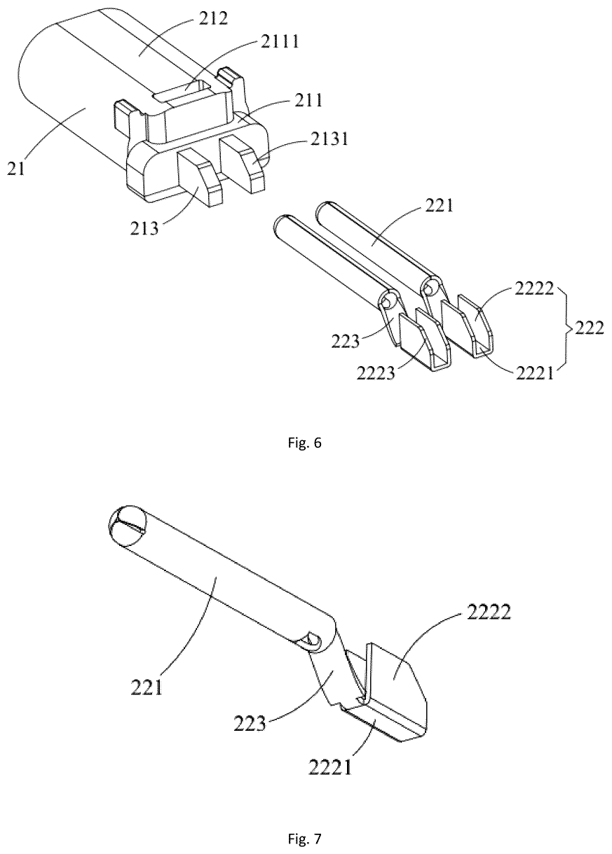

Please refer to FIG. 4 to FIG. 7, the plug 20 is used to connect with the socket 10 and includes an insulating body 21 and a plug-in terminal 22. In the present example, the insulating body 21 and the plug-in terminal 22 are integrated injection molding. The insulating body 21 includes a base 211, a plug-in portion 212 extending from the base 211 toward the socket 10, and an extension portion 213 extending from the base 211 in a direction away from the socket 10. The plug portion 212 is provided with a plug cavity 2121 for receiving the plug-in terminal 22 and the tongue plate 1114. In a case that the plug 20 is plugged into the socket 10 and matched with the socket 10, the plug portion 212 is located between the inner wall of the docking body 1112 and the tongue plate 1114.

The plug-in terminal 22 includes a docking portion 221 that is in contact with the conductive terminal 12 and a contact portion 222 that is electrically connected with the light strip 40. The docking portion 221 is in a shape of a hollow needle and can be inserted into the first conductive portion 121, so that the docking portion 221 and the first conductive portion 121 are electrically connected. The contact portion 222 includes a horizontally extending contact arm 2221 and an extension arm 2222 bent and extended from one end of the contact arm 2221. The extension portion 213 is at least partially covered by the contact arm 2221 and the extension arm 2222.

To put it simply, the plug-in terminal 22 of the present disclosure is made of bent sheet metal, so that the bending size can be adjusted according to different cross-sections of the light strip 40 to facilitate manufacturing; the docking portion 221 has a round pin structure to facilitate that the insertion of the receiving cavity 1115 is in electrical contact with the first conductive portion 121. The contact portion 222 has a square structure. The extension portion 213 is tightly covered by the contact arm 2221 and the extension arm 2222, so that the rigidity of the contact portion 222 is effectively enhanced, thereby preventing the plug-in terminal 22 from deforming and preventing incomplete contact, looseness, and other phenomena. Preferably, there are two extension arms 2222, and they are symmetrically arranged on both sides of the contact arm 2221.

As shown in FIG. 8 and FIG. 9, the plug-in terminal 22 further includes a connecting portion 223 connecting the docking portion 221 and the contact arm 2221. The connecting portion 223 extends obliquely so that a plane that the contact arm 2221 is located is lower than a plane that the docking portion 221 is located, so that the height of the contact portion 222 can be adjusted according to a bottom thickness of the light strip 40, so that the extension arm 2222 can support the lamp tube of the light strip 40. At the same time, the contact arm 2221 can closely fit the circuit board 41 of the light strip 40 to make effective contact. Of course, if the lamp tube of the light strip 40 is thick enough, the connecting portion 223 can also be set to extend horizontally, which is not limited herein.

Further, the extension arm 2222 and the extension portion 213 are both provided with chamfers to facilitate that the extension arm 2222 and the extension portion 213 are inserted into the lamp tube of the light strip 40. Specifically, an obliquely extending first guide surface 2131 is provided on the side of the extension portion 213 facing the light strip 40 to guide the plug 20 to be inserted into the light strip 40; in a thickness direction of the insulating body 21, an extension height of the extension arm 2222 is the same as an extension height of the extension portion 213. The side of the extension arm 2222 facing the light strip 40 is also provided with an obliquely extending second guide surface 2223, and the first guide surface 2131 and the second guide surface 2223 are coplanar. With this arrangement, the plug 20 can be smoothly inserted into the lamp tube of the light strip 40 by utilizing the common guidance of the first guide surface 2131 and the second guide surface 2223.

Further, the extension arm 2222 and the extension portion 213 are configured to interfere with the lamp tube of the light strip 40 so that the contact arm 2221 can closely fit the circuit board 41 of the light strip 40, thereby effectively avoiding the problem of poor contact. Preferably, appropriately raise the height of the extension arm 2222 and the height of the extension portion 213 can be selected to achieve an interference fit between the plug 20 and the light strip 40, so as to improve the reliability of electrical contact while also preventing the plug 20 falls off during installation.

Furthermore, the insulating body 21 is also provided with a stress-bearing groove 2111, in a case that the plug 20 is inserted into the receiving groove 1113, the stress-bearing groove 2111 is exposed in the fixing base 112, thus, during disassembly, the user can push the plug 20 out by the stress-bearing groove 2111.

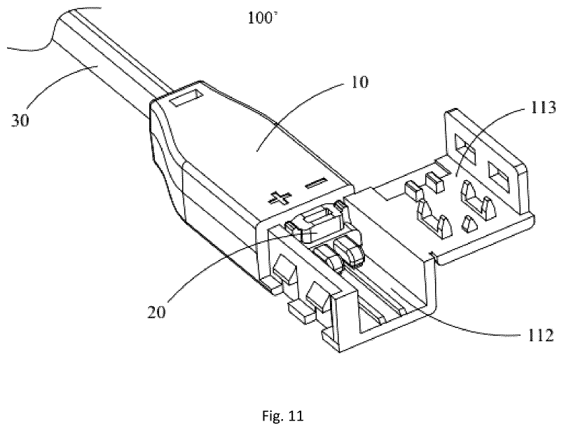

Please refer to FIG. 10, in another example of the plug 20, the insulating body 21 and the plug-in terminal 22 are integrally injection molded, the base 211 is also provided with a bone position 2112 extending in a direction away from the socket 10. In a width direction of the insulating body 21, the extension arm 2222 fits the bone position 2112 and is at least partially located between the bone position 2112 and the extension portion 213. Such arrangement can further enhance the close matching effect of the plug 20 and the light strip 40.

When using the connector assembly 100 of the present disclosure, first the plug 20 is inserted into the light strip 40, then the plug 20 and the light strip 40 are inserted into the socket 10 as a whole, and finally, the end cover 113 is snap-connected to the fixed base 112.

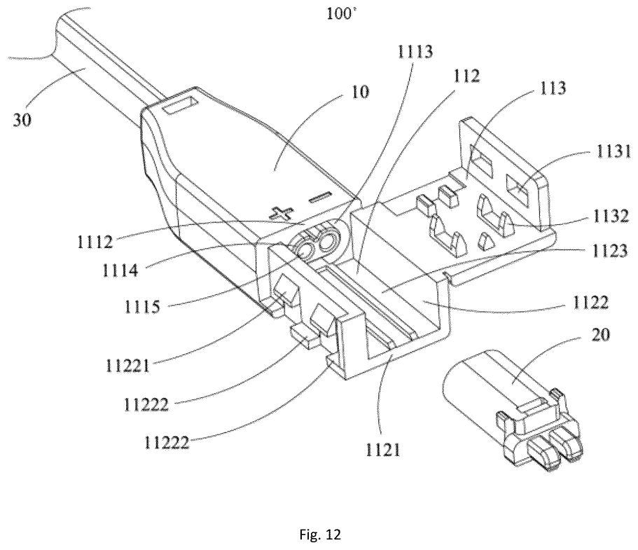

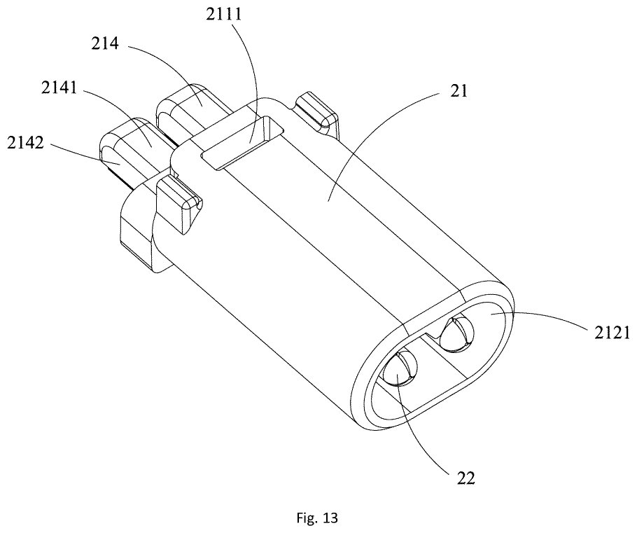

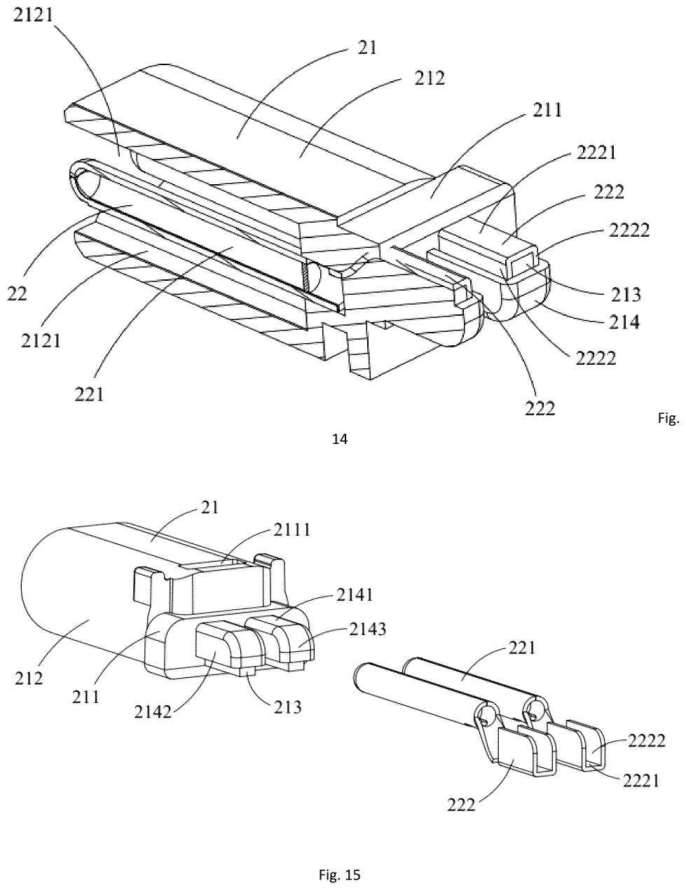

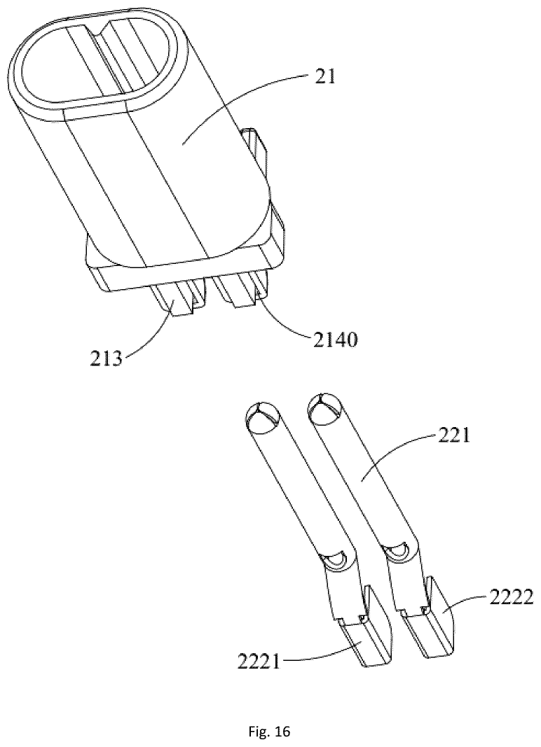

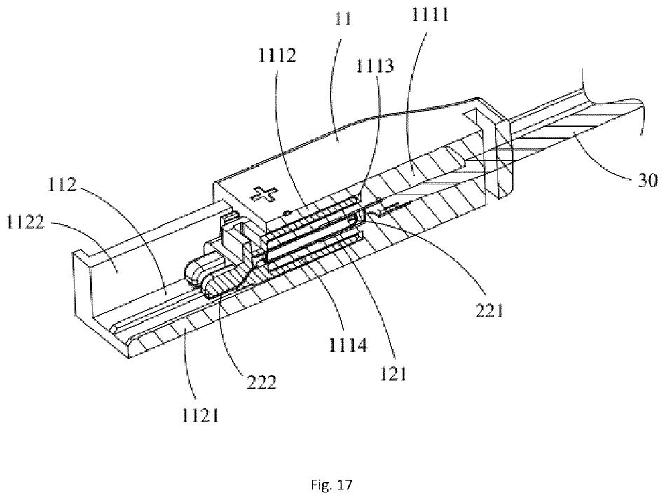

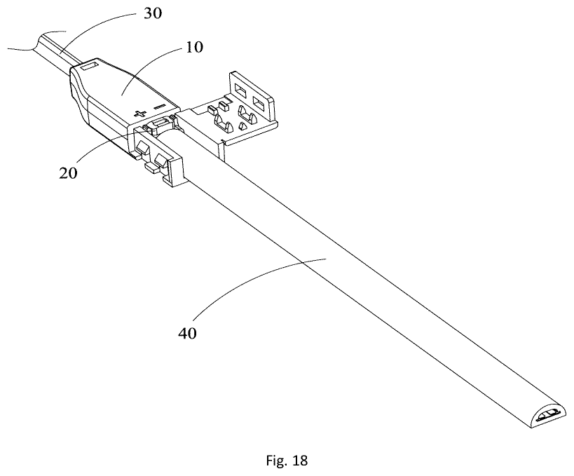

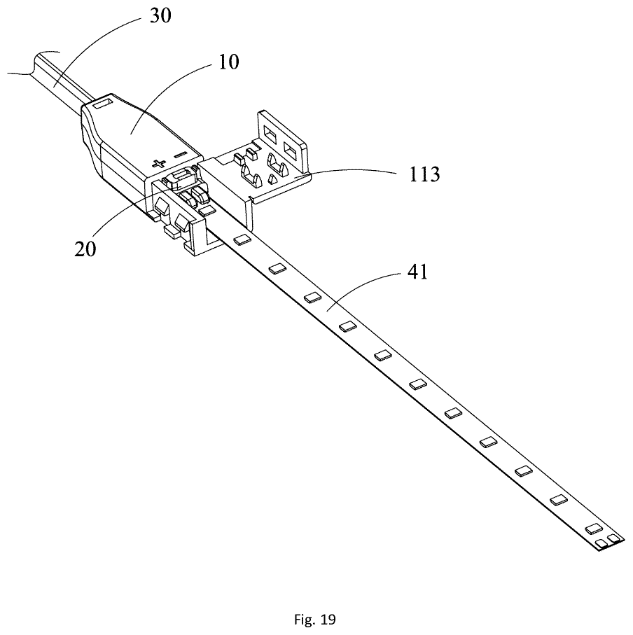

As shown in FIG. 11 to FIG. 19, it is a second example of the connector assembly 100′ of the present disclosure. In this example, the structure of the connector assembly 100′ is basically the same as that of the connector assembly 100 of the first example. The main difference lies in that the connector assembly 100′ in the present example is also provided with an insulating block 214 on the insulating body 21 to insulate and shield the plug-in terminal 22 to prevent electric shock hazards caused by operators accidentally touching the contact portion 222 of the plug-in terminal 22.

Specifically, the insulating body 21 further includes an insulating block 214 extending from the base 211 in a direction away from the socket 10. In the thickness direction of the insulating body 21, an accommodating groove 2140 downwardly opening is formed in the insulating block 214. The insulation block 214 is placed on the top of the contact portion 222 and at least a part of the contact portion 222 accommodates in the accommodating groove 2140.

Specifically, the insulating block 214 includes a first main body part 2141 extending horizontally from the base 211, second main body parts 2142 extending perpendicularly to the first main body part 2141 from both sides of the first main body part 2141, and a third main body part 2143 connects the first main body part 2141 and the two second main body parts 2142 on the side away from the base 211. The accommodating groove 2140 is formed by enclosing the first main body part 2141, the two second main body parts 2142 and the third main body part 2143 together. In other words, the insulating block 214 is generally arranged in a rectangular hollow shape and has an opening on the lower surface to provide insulation cover for the contact portion 222 and prevent electric shock hazards caused by operators accidentally touching the contact portion 222 of the plug-in terminal 22.

At least a part of the extension portion 213 is also received in the accommodating groove 2140. Preferably, in the thickness direction of the insulating body 21, the bottom of the extension portion 213 is covered by the contact arm 2221 and the extension arm 2222, and both the top of the extension portion 213 and the top of the extension arm 2222 are covered by the insulating block 214. That is to say, in the width direction of the insulating body 21, at least a part of the extension arm 2222 is located between the second main body part 2142 and the extension portion 213. With this arrangement, not only the contact arm 2221 and the extension arm 2222 can be used to cover the extension portion 213 to enhance the rigidity of the contact portion 222, the insulation block 214 can also be used to cover the extension portion 213 and the extension arm 2222 to effectively prevent users from getting electric shock during installation and disassembly.

Chamfered structures are formed on the side of the insulating block 214 facing the light strip 40 to guide the plug 20 to be inserted into the light strip 40. Specifically, the chamfered structures are formed at mutual connection positions of the first body part 2141, the second body parts 2142 and the third body part 2143, that is, a chamfered structure is formed at the connection position between the first body part 2141 and the second body part 2142. A chamfered structure is formed between the second body part 2142 and the third body part 2143, and a chamfered structure is formed between the first body part 2141 and the third body part 2143. In this way, the insulating block 214 can be smoothly inserted into the lamp tube of the light strip 40 and interferes with the light strip 40, so that the contact arm 2221 can closely fit the circuit board 41 of the light strip 40, which can effectively avoid the problem of poor contact, and at the same time, it can also prevent the plug 20 from falling off during the installation process.

Furthermore, a chamfered structure is also formed on the extending arm 2222 at a position that matches with the insulating block 214. The purpose of forming the chamfered structure is to enable the extending arm 2222 to be better accommodated in the accommodating groove 2140 of the insulating block 214. Of course, when the extension arm 2222 does not extend to the top of the insulating block 214, the chamfered structure may not be provided on the extension arm 2222, which is not limited herein.

To sum up, compared with other designs, the connector assembly 100, 100′ of the present disclosure uses the contact arm 2221 and the extension arm 2222 to cover the extension portion 213 to enhance the strength of the plug-in terminal 22, thereby making the plug-in terminal 22 will not deform, thereby avoiding incomplete contact, looseness, etc. In addition, the present disclosure also provides an insulating block 214 on the insulating body 21 and the accommodating groove 2140 downwardly opening is formed in the insulating block 214, so that the insulating block 214 can be used to cover the top of the contact portion 222 and make that at least a part of the contact portion 222 is accommodated in the accommodating groove 2140 to insulate and protect the plug-in terminal 22 to avoid the risk of electric shock caused by the operator accidentally touching the plug-in terminal 22, thereby improving the safety factor.

The purpose of the present disclosure is to provide a connector assembly that uses a contact arm and an extension arm to cover the extension portion to enhance the strength of the plug-in terminal, so as to prevent deformation of the plug-in terminals and avoid phenomena such as incomplete contact and looseness.

In order to achieve the above objects, the present disclosure provides a connector assembly, which includes:
a socket, comprising a housing and a conductive terminal; and
a plug, used to connect with the socket, comprising an insulating body and a plug-in terminal; in which the insulating body comprises a base and an extension portion extending from the base in a direction away from the socket; the plug-in terminal comprises a docking portion connected to the conductive terminal and a contact portion electrically connected to a light strip; the contact portion comprises a contact arm electrically connected to the light strip and an extension arm bent and extended from one end of the contact arm; the extension portion is at least partially covered by the contact arm and the extension arm.

Optionally, two extension arms are provided and are symmetrically arranged on both sides of the contact arm.

Optionally, a first guiding surface extending obliquely is provided on a side of the extending portion facing the light strip to guide the plug to be inserted into the light strip.

Optionally, in a thickness direction of the insulating body, an extension height of the extension arm is the same as an extension height of the extension portion, and a second guide surface extending obliquely is provided on a side of the extension arm facing the light strip, and the first guide surface is coplanar with the second guide surface.

Optionally, the plug-in terminal further comprises a connecting portion connecting the docking portion and the contact arm, and the connecting portion extends obliquely so that a plane where the contact arm is located is lower than a plane where the docking portion is located.

Optionally, the insulating body and the plug-in terminal are integrally injection molded, the base is further provided with a bone position extending in a direction away from the socket, and in a width direction of the insulating body, the extension arm is in contact with the bone position.

Optionally, a stress-bearing groove is further provided on the insulating body, so that the plug is pushed out through the stress-bearing groove during disassembly.

Optionally, the housing comprises a base, a fixing base extending from the base toward the plug, and an end cover matching the fixing base, and a receiving groove is provided in the base, the plug is inserted into the receiving groove, and the stress-bearing groove is exposed in the fixing base.

Optionally, the fixing base comprises a bottom wall and side walls arranged on both sides of the bottom wall, a first snap-fitting portion is arranged on an outer wall surface of the side wall, the end cover is correspondingly provided with a second snap-fitting portion matching with the first snap-fitting portion, and a supporting portion for supporting the light strip is further arranged on an inner wall surface of the end cover.

Optionally, the base is further provided with a tongue plate protruding from the receiving groove, and a receiving cavity is provided in the tongue plate; the conductive terminal comprises a first conductive portion matched with the docking portion and a second conductive portion electrically connected to a power line, and the first conductive portion is received in the receiving cavity; the insulating body further comprises a plug-in portion extending from the base toward the socket, the plug-in portion is provided with a plug-in cavity for accommodating the docking portion and the tongue plate; in a case that the socket and the plug are plugged in, the plug-in portion is located between an inner side wall of the base and the tongue plate.

Optionally, the insulating body further comprises an insulating block extending from the base in a direction away from the socket, and an accommodating groove downwardly opening is formed in the insulating block in a thickness direction of the insulating body, and the insulating block is covered on the top of the contact portion so that the contact portion is at least partially received in the accommodating groove.

Optionally, chamfered structures are formed on a side of the insulating block facing the light strip to guide the plug to be inserted into the light strip.

Optionally, the insulating block comprises a first main body part extending horizontally from the base, second main body parts extending perpendicularly to the first main body part from both sides of the first main body part, and a third main body part connecting the first main body part and the two second main body parts on the side away from the base, the chamfered structures are formed at mutual connection positions of the first main body part, the second main body parts and the third main body part, and the accommodating groove is formed by the first main body part, the two second main body parts and the third main body part.

Optionally, in the thickness direction of the insulating body, a bottom part of the extension portion is covered by the contact arm and the extension arm, and a top part of the extension portion and a top part of the extension arm are both covered by the insulating block.

Optionally, the extension arm, the extension portion, and the insulating block are all configured to be interference fit with the light strip.

The beneficial effect of the present disclosure is: the connector assembly of the present disclosure uses the contact arm and the extension arm to cover the extension portion to enhance the strength of the plug-in terminal, so that the plug-in terminal will not deform, thereby avoiding incomplete contact, loosening and other phenomena.

The above examples are only used to illustrate the technical solutions of the present disclosure and are not to limited to these. Although the present disclosure has been described in detail with reference to the examples, those skilled in the art should understand that the technical solutions of the present disclosure can be modified or equivalently replaced without departing from the spirit and scope of the technical solution of the present disclosure.

1. A connector assembly, comprising:
a socket, comprising a housing and a conductive terminal; and
a plug, used to connect with the socket, comprising an insulating body and a plug-in terminal; wherein the insulating body comprises a base and an extension portion extending from the base in a direction away from the socket; the plug-in terminal comprises a docking portion connected to the conductive terminal and a contact portion electrically connected to a light strip; the contact portion comprises a contact arm electrically connected to the light strip and an extension arm bent and extended from one end of the contact arm; and the extension portion is at least partially covered by the contact arm and the extension arm.

2. The connector assembly according to claim 1, wherein two extension arms are provided and are symmetrically arranged on both sides of the contact arm.

3. The connector assembly according to claim 1, wherein a first guiding surface extending obliquely is provided on a side of the extending portion facing the light strip to guide the plug to be inserted into the light strip.

4. The connector assembly according to claim 3, wherein in a thickness direction of the insulating body, an extension height of the extension arm is the same as an extension height of the extension portion, and a second guide surface extending obliquely is provided on a side of the extension arm facing the light strip, and the first guide surface is coplanar with the second guide surface.

5. The connector assembly according to claim 1, wherein the plug-in terminal further comprises a connecting portion connecting the docking portion and the contact arm, and the connecting portion extends obliquely so that a plane where the contact arm is located is lower than a plane where the docking portion is located.

6. The connector assembly according to claim 1, wherein the insulating body and the plug-in terminal are integrally injection molded, the base is further provided with a bone position extending in a direction away from the socket, and in a width direction of the insulating body, the extension arm is in contact with the bone position.

7. The connector assembly according to claim 1, wherein a stress-bearing groove is further provided on the insulating body, so that the plug is pushed out through the stress-bearing groove during disassembly.

8. The connector assembly according to claim 7, wherein the housing comprises a base, a fixing base extending from the base toward the plug, and an end cover matching the fixing base, and a receiving groove is provided in the base, the plug is inserted into the receiving groove, and the stress-bearing groove is exposed in the fixing base.

9. The connector assembly according to claim 8, wherein the fixing base comprises a bottom wall and sidewalls arranged on both sides of the bottom wall, a first snap-fitting portion is arranged on an outer wall surface of the side wall, the end cover is correspondingly provided with a second snap-fitting portion matching with the first snap-fitting portion, and a supporting portion for supporting the light strip is further arranged on an inner wall surface of the end cover.

10. The connector assembly according to claim 8, wherein the base is further provided with a tongue plate protruding from the receiving groove, and a receiving cavity is provided in the tongue plate; the conductive terminal comprises a first conductive portion matched with the docking portion and a second conductive portion electrically connected to a power line, and the first conductive portion is received in the receiving cavity; the insulating body further comprises a plug-in portion extending from the base toward the socket, the plug-in portion is provided with a plug-in cavity for accommodating the docking portion and the tongue plate; in a case that the socket and the plug are plugged in, and the plug-in portion is located between an inner side wall of the base and the tongue plate.

11. The connector assembly according to claim 1, wherein the insulating body further comprises an insulating block extending from the base in a direction away from the socket, and an accommodating groove downwardly opening is formed in the insulating block in a thickness direction of the insulating body, and the insulating block is covered on the top of the contact portion so that the contact portion is at least partially received in the accommodating groove.

12. The connector assembly according to claim 11, wherein chamfered structures are formed on a side of the insulating block facing the light strip to guide the plug to be inserted into the light strip.

13. The connector assembly according to claim 12, wherein the insulating block comprises a first main body part extending horizontally from the base, second main body parts extending perpendicularly to the first main body part from both sides of the first main body part, and a third main body part connecting the first main body part and the two second main body parts on the side away from the base, the chamfered structures are formed at mutual connection positions of the first main body part, the second main body parts and the third main body part, and the accommodating groove is formed by the first main body part, the two second main body parts and the third main body part.

14. The connector assembly according to claim 11, wherein in the thickness direction of the insulating body, a bottom part of the extension portion is covered by the contact arm and the extension arm, and a top part of the extension portion and a top part of the extension arm are both covered by the insulating block.

15. The connector assembly according to claim 11, wherein the extension arm, the extension portion, and the insulating block are all configured to be interference fit with the light strip.
